(19) United States
(12) Patent Application Publication
(10) Pub. No.: US 2014/0336925 A1
(43) Pub. Date: Nov. 13, 2014

(54) DISPLAYING MAP ICONS BASED ON A DETERMINED ROUTE OF TRAVEL

(71) Applicant: Jeremiah Joseph Akin, Pleasant Hill, CA (US)

(72) Inventor: Jeremiah Joseph Akin, Pleasant Hill, CA (US)

(21) Appl. No.: 13/890,631

(22) Filed: May 9, 2013

(51) Int. Cl. G01C 21/00; G09G 5/36

(52) U.S. Cl. CPC G01C 21/00; G09G 5/363
USPC 701/457; 345/619

(57) ABSTRACT

Example methods and systems to display map icons, such as icons associated with a traveler or other user associated with a mobile device, based on a determined and/or identified route of travel are described. In some example embodiments, the methods and systems access information identifying a movement of a mobile device, determine a mode of travel of the mobile device, and cause an icon to be displayed, via a mapping application supported by the mobile device, that is based on the determined mode of travel.

### TECHNICAL FIELD

This application relates generally to information retrieval and, specifically, to a system and method for displaying map icons based on determined routes of travel.

### BACKGROUND

Typical mobile device mapping applications provide users with route directions (e.g., directions on how to travel from one location to another), information (e.g., information identifying restaurants, points of attraction, and so on), interactive elements (e.g., links to locations displayed via a map), and so on. Furthermore, they may also facilitate searching for geographic based information, connecting users based on shared locations, providing images associated with locations, and so on. However, such maps and associated information are often presented via user interfaces with limited screen real estate and may, in some cases, be overwhelming or distracting to users not interested in much of the information and/or services provided by the mapping applications.

### BRIEF DESCRIPTION OF THE DRAWINGS

The present technology is illustrated by way of example, and not by way of limitation, in the figures of the accompanying drawings.

FIG. 1 is a block diagram illustrating a network architecture of a system to display map icons based on determined routes of travel, in some example embodiments.

FIG. 2 is a block diagram illustrating an icon display system, in some example embodiments.

FIG. 3 is a flow diagram illustrating a method for displaying map icons based on determined routes of travel, in some example embodiments.

FIG. 4 is a flow diagram illustrating a method for determining a mode of travel based on a travel route, in some example embodiments.

FIG. 5 is a flow diagram illustrating a method for selecting a map icon based on a travel context, in some example embodiments.

FIGS. 6A-6D are display diagrams illustrating example user interfaces that display icons within online maps, in some example embodiments.

FIG. 7 shows a diagrammatic representation of a machine, in the example form of a computer system, within which a set of instructions may be executed to cause the machine to perform any one or more of the methodologies discussed herein.

### DETAILED DESCRIPTION

### Overview

Example methods and systems to display map icons, such as icons associated with a traveler or other user associated with a mobile device, based on a determined and/or identified route of travel are described. In some example embodiments, the methods and systems access information identifying a movement of a mobile device, determine a mode of travel of the mobile device, and cause an icon to be displayed, via a mapping application supported by the mobile device, that is based on the determined mode of travel.

For example, the methods and systems may identify that a mobile device is moving at a speed and/or via a geographical route that indicates a user associated with the mobile device is walking, and cause the mapping application to display a icon depicting a walking man or woman within the map, such as at a location within the map representative of the geographic location of the user associated with the mobile device. As another example, the methods and systems may identify a mobile device is traveling along a geographic route that is associated with a certain subway line in a city, and cause the mapping application to display an icon depicting a subway train along with other map elements associated with the subway train (elements identifying stops, elements identifying the route within the map, and so on).

Therefore, in some example embodiments, the methods and systems may access information identifying a current mode of travel or movement of a mobile device (or, user associated with the mobile device), select a map icon associated with the mode of travel, and cause the selected map icon to be displayed within a running map application supported by the mobile device.

### Example Systems and Methods

In the following description, for purposes of explanation, numerous specific details are set forth in order to provide a thorough understanding of the present disclosure. It may be evident, however, to one skilled in the art that the subject matter of the present disclosure may be practiced without these specific details.

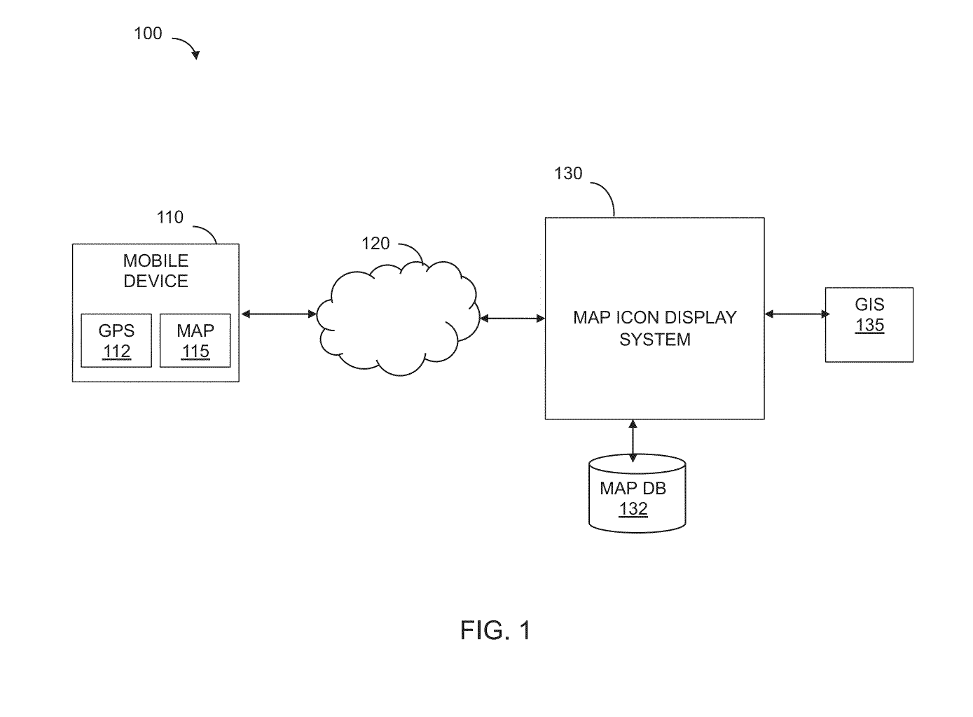

FIG. 1 is a block diagram illustrating a network architecture of a system 100 to display map icons based on determined routes of travel, in some example embodiments.

For example, the network system 100 may be or include a network-based architecture where clients may communicate and exchange data within the network system 100. The data may pertain to various functions (e.g., transmittal and/or identification of route or geographic information) and aspects (e.g., information associated with a location or icon on a map) associated with the network system 100 and its users. Although illustrated herein as a client-server architecture as an example, other example embodiments may include other network architectures, such as a peer-to-peer or distributed network environments.

A data exchange platform, in an example form of a network-based map icon display system 130, may provide server-side functionality via a network 120 (e.g., the Internet) to one or more clients, such as a mobile device 110. The one or more mobile devices 110 (e.g., a smart phone, a tablet, a laptop, a car-based global positioning system (GPS) device, and so on) may be associated with users that utilize the network system 100 and, more specifically, the map icon display system 130 to exchange data over the network 120. These transactions may include transmitting, receiving (e.g., communicating), and processing data to, from, and regarding content and users of the network system 100. The data may include, but are not limited to, global positioning system (GPS) data (e.g., data captured by a GPS component 112), geographic information system (GIS) data (e.g., data captured and/or collected by a GIS 135), user context data, displayable content (e.g., icons, map elements, and other user interface display elements), device movement data, and so on. The data may be stored in various locations, such as in a map database 132 associated with the map icon display system 130.

In various example embodiments, the data exchanges within the network system 100 may be dependent upon user-selected functions available through one or more client or user interfaces (UIs). The UIs may be associated with and/or supported by the mobile device 110, such as via a web client, a programmatic client, or other component capable of facilitating communications between the mobile device 110 and the map icon display system 130. For example, the mobile device 110 may include a mapping application 115 or other application configured to display maps and other geographical information (e.g., route information along with map elements overlaid onto the map) via the UIs supported by the mobile device 110. Example mapping applications 115 may include mapping applications provided by Google, Microsoft, Yahoo, Garmin, GIS based maps, and so on.

Thus, the example network system 100 may facilitate the exchange of data between the mobile device 110 and the map icon display system 130, enabling the map icon display system 130 to receive or otherwise access information identifying a current mode of travel or movement of a mobile device 110 (or, user associated with the mobile device 110), select a map icon associated with the mode of travel, and cause the selected map icon to be displayed within a running map application supported by the mobile device 110 (e.g., map application 115), among other things.

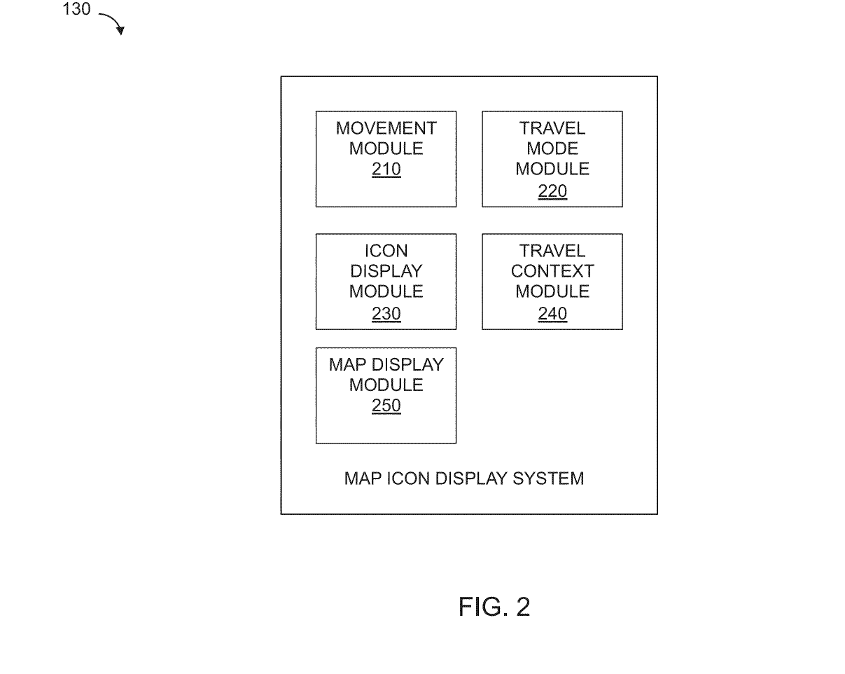

FIG. 2 is a block diagram illustrating the map icon display system 130, in some example embodiments. The map icon display system 130 may be hosted on dedicated or shared server machines (not shown) that are communicatively coupled to enable communications between the server machines. The multiple components, themselves, are communicatively coupled (e.g., via appropriate interfaces), either directly or indirectly, to each other and to various data sources, to allow information to be passed between the components or to allow the components to share and access common data. Furthermore, the components may access the one or more map database(s) 132 via one or more database servers.

As illustrated in FIG. 2, the map icon display system 130 includes a variety of functional modules. One skilled in the art will appreciate that the functional modules are implemented with a combination of software (e.g., executable instructions, or computer code) and hardware (e.g., at least a memory and processor). Accordingly, as used herein, in some example embodiments, a module is a processor-implemented module and represents a computing device having a processor that is at least temporarily configured and/or programmed by executable instructions stored in memory to perform one or more of the particular functions that are described herein. The map icon display system 130 may include a movement module 210, a travel mode module 220, an icon display module 230, a travel context module 240, and a map display module 250.

In some example embodiments, the movement module 210 is configured and/or programmed to access and/or receive information identifying a movement of a mobile device 110. The movement module 210 may access information from the GPS component 115 of the mobile device 110 and/or the GIS 135, such as information identifying a geographic route traveled or currently being traveled by the mobile device 110, information identifying a speed traveled or currently being traveled by the mobile device 110, information identifying a geographic location of the mobile device 110, and so on.

In some example embodiments, the travel mode module 220 is configured and/or programmed to determine a mode of travel of the mobile device 110. For example, the travel mode module 220 may determine a pedestrian mode of travel (e.g., walking, running), a biking mode of travel, a driving mode of travel, a public transportation mode of travel (e.g., subway, bus, train, or other), a water-based transportation mode of travel (e.g., boat, ferry, or other), a flying mode of travel (e.g., airplane or other), a sports-based mode of travel (e.g., skiing or other), and so on.

In some example embodiments, the travel mode module 220 may compare current movement information, such as information received from the GPS component 115, to geo-location information received from the geographic information system 135 and determine the mode of travel based on the comparison. For example, the travel mode module 220 may compare the GPS information to the GIS information, identify a current route being traveled by the mobile device 110, and determine the mode of travel based on the identified route being traveled by the mobile device 110.

In some example embodiments, the travel mode module 220 may determine the mode of travel based on global positioning information received from the GPS component 115 that is associated with a current movement of the mobile device 110. For example, the travel mode module 220 may identify, based on GPS information, the mobile device 110 is traveling at a certain rate of speed, and/or along a certain route, and determine the mode of travel based on the identified rate of speed and/or route of travel.

In some example embodiments, the icon display module 230 is configured and/or programmed to cause an icon to be displayed, via a mapping application supported by the mobile device, which is based on the determined mode of travel. For example, the icon display module 230 may select and/or render an icon that is associated with the determined mode of travel, and cause the mapping application 115 to display the selected or rendered icon.

The icon display module 230 may cause the display of various different icons, map characteristics (e.g., certain types of maps) and/or other display elements that are associated with a mode of travel. The icon display module 230 may access, retrieve, and/or otherwise obtain the icons and/or map elements from the map database 132, or other locations.

For example, the map database 132 may include one or more data structures or tables that relate icons, map elements, and/or map characteristics to travel modes, among other information. Table 1 depicts an example data structure:

TABLE 1

| Travel Mode | User Icon | Map Type | Map Elements |
|---|---|---|---|
| walking | Walker.img | Standard map | Standard |
| Driving | Car.img | Street map | Gas stations, traffic |
| | | | information |
| On a bus | Bus.img | Street map | Bus stops, bus routes |
| Biking | Bike.img | Bike map | Terrain map |

Following the example of Table 1, the data structure relates travel mode to various display elements. For example, a travel mode of “driving” is associated with a user icon of a car, a street map, and other display elements, such as gas station icons and traffic information elements. Of course, the data structures stored in the map database 132 may include other information not shown in Table 1.

Example icons may include an icon of a walking or running person when the mode of travel is determined to be a user who is walking or running, an icon of a car or truck when the mode of travel is determined to be a user driving a car or truck, an icon of a subway, bus, or train when the mode of travel is determined to be a user travelling by public transportation, and so on.

In some example embodiments, the icon display module 230 may select and/or render sponsored icons to be displayed and/or sponsored information to be displayed along with displayed icons. The icon display module 230 may identify a sponsor associated with the determined module of travel, and cause an icon to be displayed that is associated with the identified sponsor. For example, a running shoe company may sponsor a running mode of travel, and the icon display module 230 may select an icon of a woman running in gear promoting the running shoe company's brand when a determined mode of travel is a running or walking mode of travel.

In some example embodiments, the travel context module 240 is configured and/or programmed to access context information associated with the determined mode of travel. For example, the travel context module 240 may receive and/or otherwise access information from various components, devices, and/or applications supported by the mobile device 110, such as information associated with a time of day, information associated with current weather conditions, information associated with a user's schedule, and so on.

Using the accessed context information, the icon display module 230 may cause an icon to be displayed that is based on the determined mode of travel and on the context information, and/or may cause an icon to be displayed that graphically changes based on the context information.

For example, the icon display module 230 may cause a “car with headlights” icon to be displayed when the travel mode module 220 determines a current mode of travel of the mobile device 110 is car travel, and the travel context module 240 accesses information indicating the time of day is 11:00 PM at night. As another example, the icon display module 230 may cause a “person with umbrella” icon to be displayed when the travel mode module 220 determines a current mode of travel of the mobile device 110 is walking, and the travel context module 240 accesses information indicating the current weather is rain.

In some example embodiments, a map display module 250 is configured to cause a mapping application 115 to display map elements that are associated with the displayed icon. The map display module 250 may cause the mapping application 115 to display map elements based on the determined mode of travel and/or based on the displayed icon.

For example, when the travel mode module 220 determines the mode of travel is associated with car travel, the map display module 250 may cause the mapping application 115 to display icons associated with gas stations along the route of travel, such as icons associated with gas stations that sponsored the car mode of travel. As another example, when the icon display module 230 causes a runner to be displayed, the map display module 250 may cause the mapping application 115 to display icons associated with water fountains and/or public bathrooms proximate to a user associated with the mobile device 110.

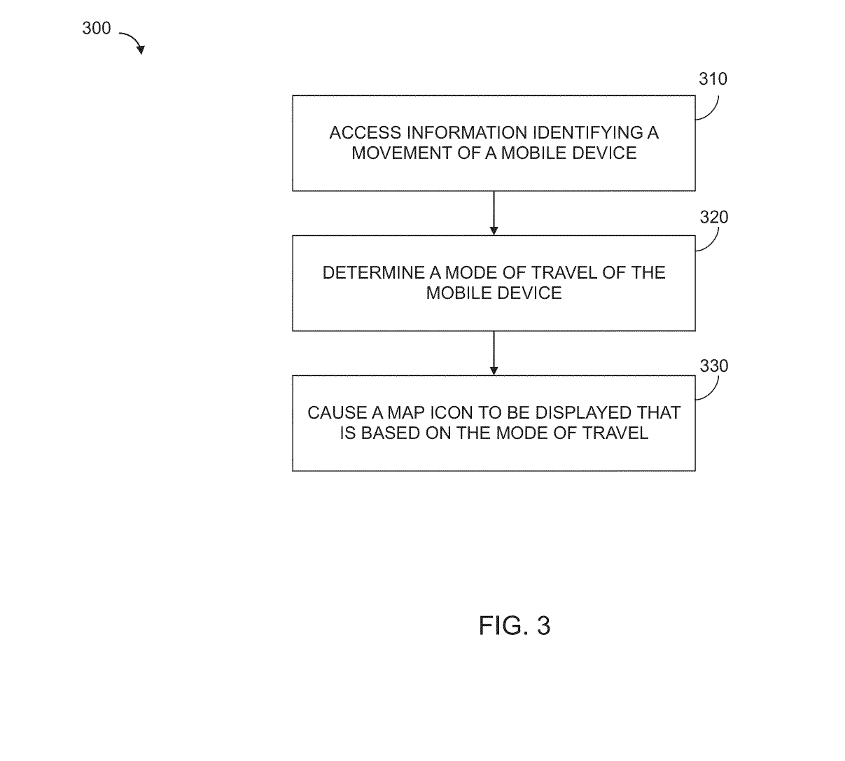

As described herein, the map icon display system 130 may perform various methods in order to display map icons associated with determined routes of travel, among other things. FIG. 3 is a flow diagram illustrating a method 300 for displaying map icons based on determined routes of travel, in some example embodiments. The method 300 may be performed by the map icon display system 130 and is, accordingly, described herein merely by way of reference thereto. It will be appreciated that the method 300 may be performed on any suitable hardware.

In operation 310, the map icon display system 130 accesses information identifying a movement of a mobile device 110. For example, the movement module 210 may access information from the GPS component 112 of the mobile device 110 and/or the GIS 135, such as information identifying a geographic route traveled or currently being traveled by the mobile device 110, information identifying a speed traveled or currently being traveled by the mobile device 110, information identifying a geographic location of the mobile device 110, and so on.

In operation 320, the map icon display system 130 determines a mode of travel for the mobile device 110. For example, the travel mode module 220 may determine a pedestrian mode of travel (e.g., walking, running, or other), a public transportation mode of travel (e.g., biking mode of travel, a driving mode of travel, a subway, bus, train, or other), a water-based transportation mode of travel (e.g., boat, ferry, or other), a flying mode of travel (e.g., airplane or other), a sports-based mode of travel (e.g., skiing or other), and so on.

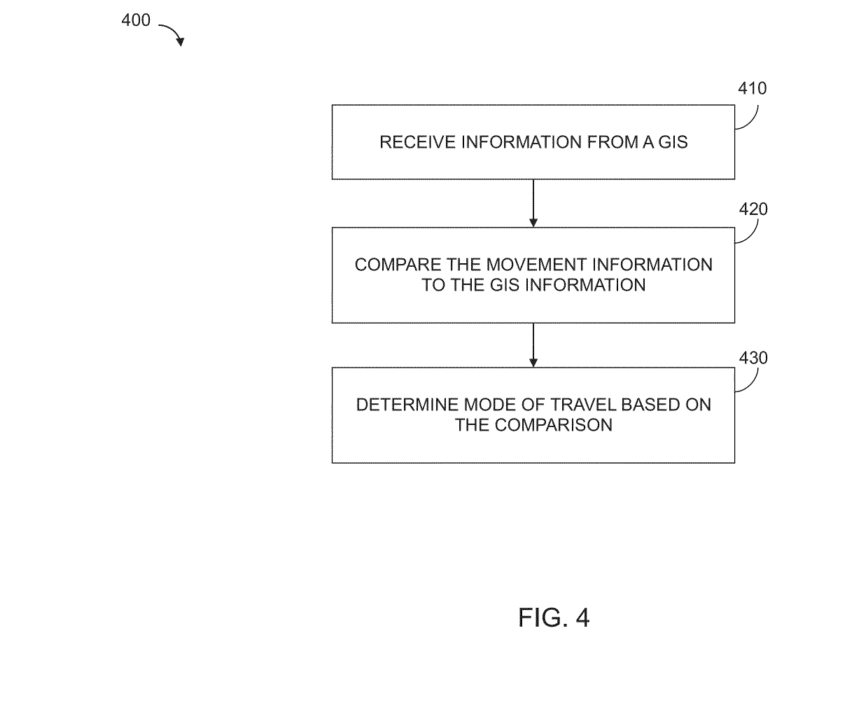

As described herein, in some example embodiments, the travel mode module 220 may compare current movement information, such as information received from the GPS component 112, to geo-location information received from the geographic information system 135, and determine the mode of travel based on the comparison. FIG. 4 is a flow diagram illustrating a method 400 for determining a mode of travel based on a travel route, in some example embodiments. The method 400 may be performed by the travel mode module 220 and is, accordingly, described herein merely by way of reference thereto. It will be appreciated that the method 400 may be performed on any suitable hardware.

In operation 410, the travel mode module 220 receives and/or accesses information from a GIS, such as GIS 135. For example, the travel mode module 220 may receive information from the GIS 135 that identifies a geographic topology, information that identifies geographic infrastructure elements (e.g., roads, paths, trails, subway tunnels, bridges, waterways), and/or other information relevant to determining how a person may be traveling through a location or area.

In operation 420, the travel mode module 220 compares the movement information to the received and/or accessed GIS information. For example, the travel mode module 220 may compare movement information of geo-positioning coordinates provided by the GPS component 112 to geographic feature information provided by the GIS 135, such as information that identifies a type of travel infrastructure located at the geo-positioning coordinates.

In operation 430, the travel mode module 220 determines the mode of travel based on the comparison. For example, when the comparison of operation 420 indicates that a subway line is located at a current geographic location of the mobile device 110, the travel mode module 220 may determine that a user associated with the mobile device 110 is travelling via a subway train.

Referring back to FIG. 3, in operation 330, the map icon display system 130 causes an icon to be displayed via a mapping application 115 supported by the mobile device 110, which is based on the determined mode of travel. For example, the icon display module 230 may cause the display of various different icons and/or other display elements that are associated with a mode of travel, and may access, retrieve, and/or otherwise obtain the icons from the map database 132, or other locations.

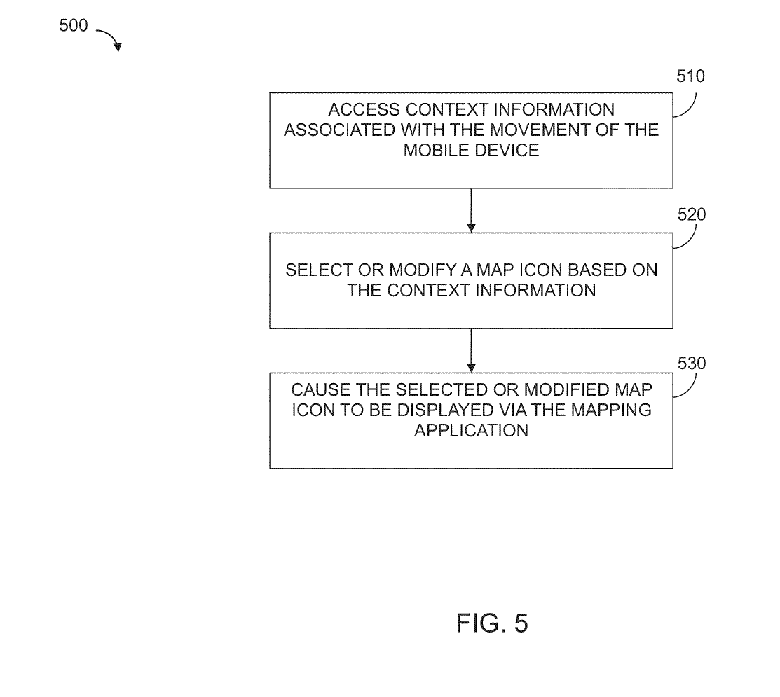

As described herein, in some example embodiments, the icon display module 230 may select and/or render map icons based on a current travel context for the mobile device 110. FIG. 5 is a flow diagram illustrating a method 500 for selecting a map icon based on a travel context, in some example embodiments. The method 500 may be performed by the icon display module 230 and/or the travel context module 240 and is, accordingly, described herein merely by way of reference thereto. It will be appreciated that the method 500 may be performed on any suitable hardware.

In operation 510, the travel context module 240 accesses context information associated with the movement of the mobile device 110. For example, the travel context module 240 may access temporal information, weather information, scheduling information, and so on.

In operation 520, the icon display module 230 selects and/or modifies a map icon based on the context information, and in operation 530, causes the mapping application 115 to display the selected or modified map icon. For example, the icon display module 230 may cause an icon to be displayed in a first configuration during one time of day (e.g., during the day), and cause the icon to be displayed in a second configuration during another time of day (e.g., during the night). Additionally, the map display module 250 may utilize context information when selected map elements to display that are based on a determined mode of travel.

The following examples may illustrate the selection or modification of icons based on context information:

For a determined mode of travel of walking, the icon display module 230 may cause a “walking person wearing shorts” icon to be displayed when the weather is warm, and a “walking person wearing a hat” icon when the weather is cold.

For a determined mode of travel of driving, the icon display module 230 may cause a car icon to be displayed in green when the current route of travel is without traffic, and the car icon to be to be displayed in red when the current route of travel is under heavy traffic; and/or

For a determined mode of travel of flying, the icon display module 230 may display map elements of landmarks during the beginning of a flight, and map elements for a user's preferred car rental company and hotel when the flight is landing; and so on.

Of course the icon display module 230 may cause other map icons or map elements to be displayed under various other scenarios.

As described herein, the map icon display system 130 may present and/or display a variety of different icons associated with a user of the mobile device 110, based on the mode of travel of the mobile device 110. For example, the map icon display system 130 may access information identifying a current mode of travel or movement of a mobile device 110 (or, user associated with the mobile device 110), select a map icon associated with the mode of travel, and cause the selected map icon to be displayed within a running map application supported by the mobile device 110.

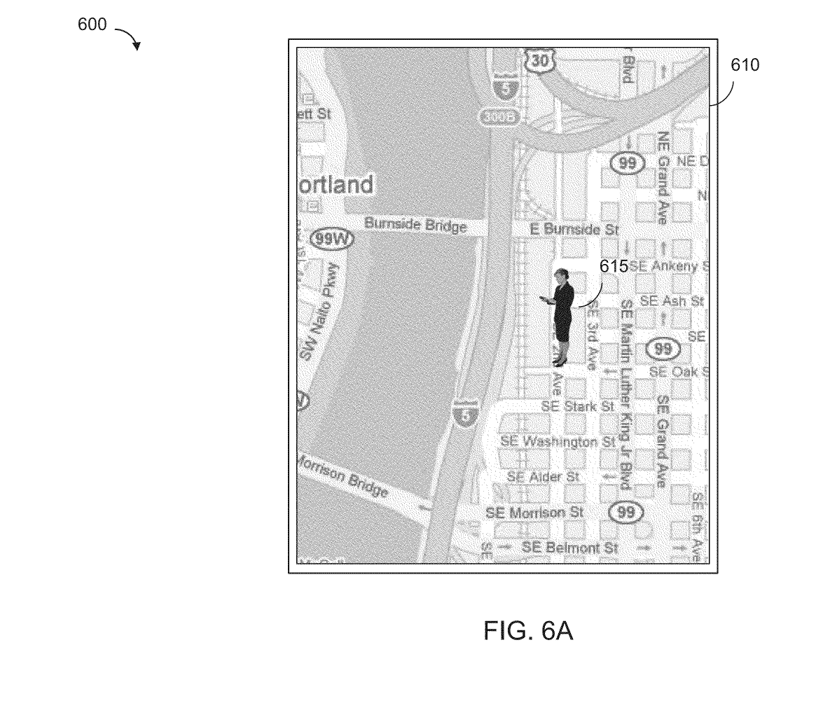

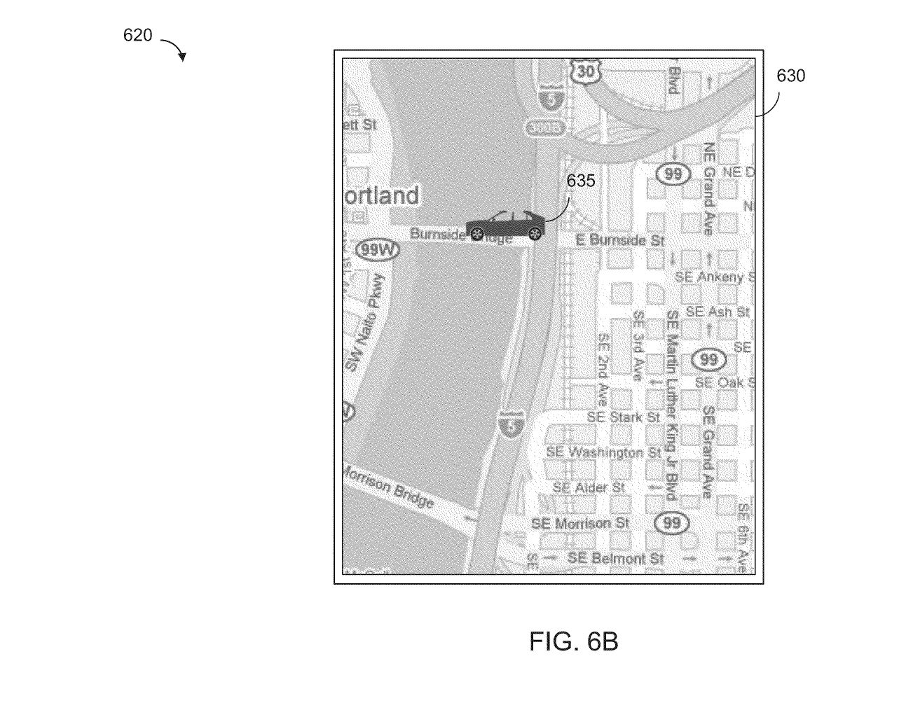

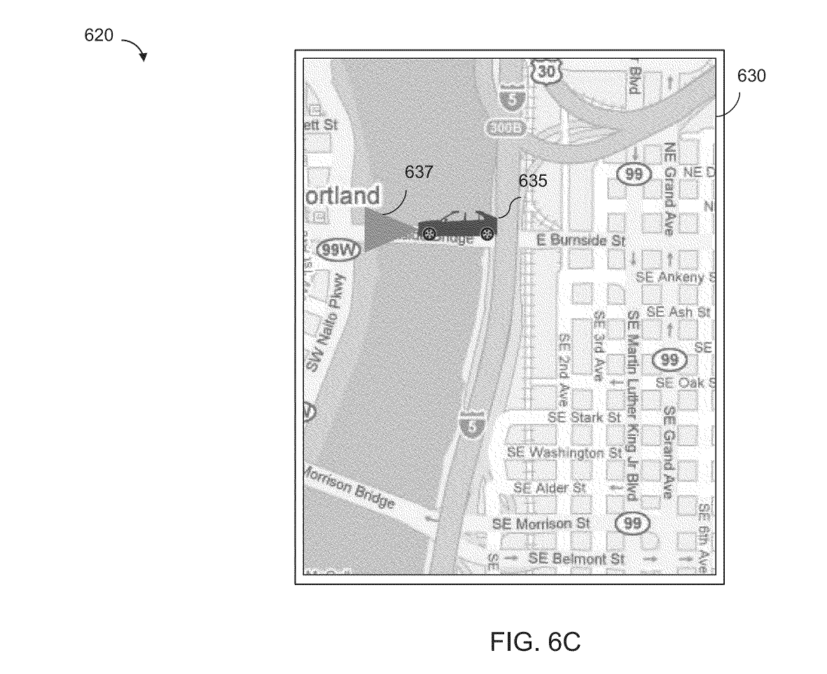

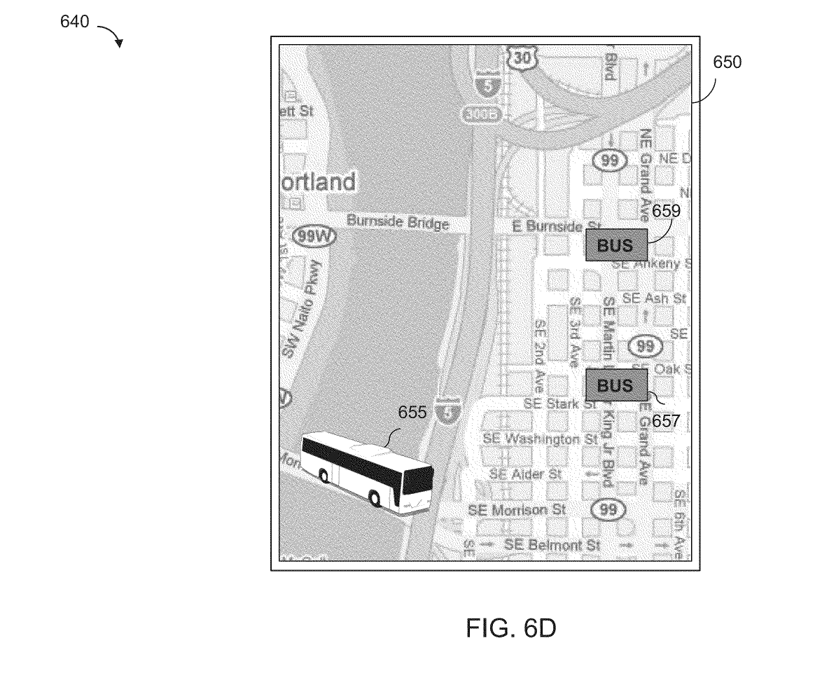

FIGS. 6A-6D are display diagrams illustrating example user interfaces that display online maps, in some example embodiments. FIG. 6A depicts a user interface 600 of the mobile device 110, which presents a walking icon 615 within a map 610 displayed by a mapping application 115 supported by the mobile device 110. For example, the map icon display system 130 determines that a user associated with the mobile device 110 is walking, and causes the user interface 600 to display the walking icon 615 via the map 610.

FIG. 6B depicts a user interface 620 of the mobile device 110, which presents a car icon 635 within a map 630 displayed by a mapping application 115 supported by the mobile device 110. For example, the map icon display system 130 determines a user associated with the mobile device 110 is driving, and causes the user interface 620 to display the car icon 635 via the map 630.

FIG. 6C depicts the user interface 620 of the mobile device 110, which presents the car icon 635 within the map 630 displayed by a mapping application 115 supported by the mobile device 110. In this example, the map icon display system 130 determines that the user associated with the mobile device 110 is driving at night, and modifies the car icon 635 by displaying headlight graphics 637 via the map 630.

FIG. 6D depicts a user interface 640 of the mobile device 110, which presents a bus icon 655, along with display elements 657, 659 associated with bus stops, within a map 650 displayed by a mapping application 115 supported by the mobile device 110. For example, the map icon display system 130 determines that a user associated with the mobile device 110 is riding a certain bus, and causes the user interface 640 to display the bus icon 655 and the associated bus stop elements 657, 659 via the map 630.

The bus stop elements 657, 659 (and other elements described herein) may, for example, be user-selectable, and provide information about bus times, bus routes, and so on, when selected by the user. Of course, the map icon display system 130 may display other icons, map elements, and/or maps not shown in the Figures.

Thus, the map icon display system 130 enables mapping applications to display icons to a user that are based on the user's mode of travel, among other things. By rendering icons that are related to a mode of travel, the map icon display system 130 may provide targeted and/or relevant information to a user, may facilitate a deeper engagement between the user and his/her mapping application, may entertain the user, and so on.

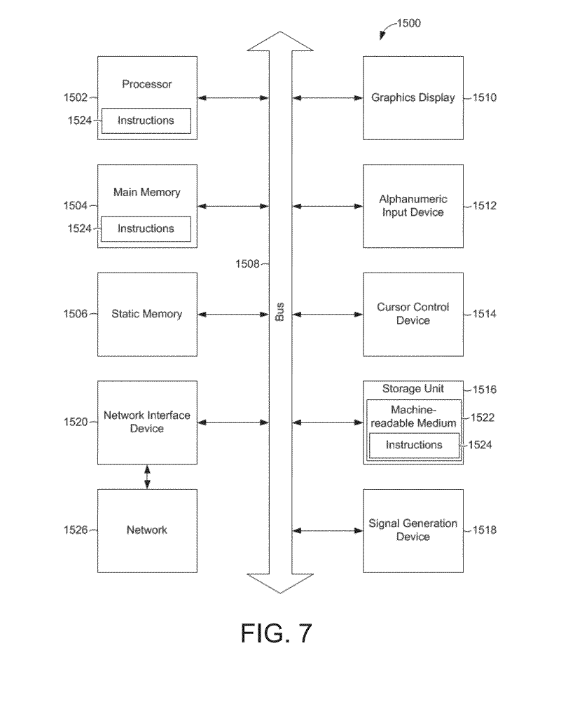

FIG. 7 shows a diagrammatic representation of a machine in the exemplary form of a computer system 1500 within which a set of instructions 1524 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions 1524 (sequential or otherwise) that specify actions to be taken by that machine. Further, while only a single machine is illustrated, the term “machine” shall also be taken to include any collection of machines that individually or jointly execute a set (or multiple sets) of instructions 1524 to perform any one or more of the methodologies discussed herein.

The example computer system 1500 includes a processor 1502 (e.g., a central processing unit (CPU), a graphics processing unit (GPU), or both), a main memory 1504 and a static memory 1506, which communicate with each other via a bus 1508. The computer system 1500 may further include a graphics display unit 1510 (e.g., a liquid crystal display (LCD) or a cathode ray tube (CRT)). The computer system 1500 also includes an alphanumeric input device 1512 (e.g., a keyboard), a cursor control device 1514 (e.g., a mouse), a storage unit 1516, a signal generation device 1518 (e.g., a speaker) and a network interface device 1520.

The storage unit 1516 includes a machine-readable medium 1522 on which is stored one or more sets of instructions 1524 (e.g., software) embodying any one or more of the methodologies or functions described herein. The instructions 1524 may also reside, completely or at least partially, within the main memory 1504 and/or within the processor 1502 during execution thereof by the computer system 1500, the main memory 1504 and the processor 1502 also constituting machine-readable media. The instructions 1524 may be further transmitted or received over a network 1526 via the network interface device 1520.

While the machine-readable medium 1522 is shown in an exemplary embodiment to be a single medium, the term “machine-readable medium” should be taken to include a single medium or multiple media (e.g., a centralized or distributed database, and/or associated caches and servers) that store the one or more sets of instructions 1524. The term “machine-readable medium” shall also be taken to include any medium that is capable of storing, encoding or carrying a set of instructions 1524 for execution by the machine and that cause the machine to perform any one or more of the methodologies of the present disclosure. The term “machine-readable medium” shall accordingly be taken to include, but not limited to, solid-state memories, optical and magnetic media, and carrier wave signals.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may, accordingly, configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

Although the present disclosure has been described with reference to specific exemplary embodiments, it may be evident that various modifications and changes may be made to these embodiments without departing from the broader spirit and scope of the disclosure. Accordingly, the specification and drawings are to be regarded in an illustrative rather than a restrictive sense.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. Therefore, this Detailed Description, is not to be taken in a limiting sense, and the scope of various embodiments is defined only by the appended claims, along with the full range of equivalents to which such claims are entitled.

Such embodiments of the subject matter may be referred to herein, individually and/or collectively, by the term “invention” merely for convenience and without intending to voluntarily limit the scope of this application to any single invention or inventive concept if more than one is in fact disclosed. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The preceding technical disclosure is intended to be illustrative, and not restrictive. For example, the above-described embodiments (or one or more aspects thereof) may be used in combination with each other. Other embodiments will be apparent to those of skill in the art upon reviewing the above description.

In this document, the terms “a” or “an” are used, as is common in patent documents, to include one or more than one. In this document, the term “or” is used to refer to a nonexclusive or, such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

What is claimed is:

1. A system, comprising:
a movement module that is configured to access information identifying a movement of a mobile device;
a travel mode module that is configured to determine a mode of travel of the mobile device based on the accessed information; and
an icon display module that is configured to cause an icon to be displayed, via a mapping application supported by the mobile device, which is based on the determined mode of travel.

2. The system of claim 1, wherein the movement module is configured to receive current movement information from a global positioning system supported by the mobile device; and wherein the travel mode module is configured to:
compare the received current movement information to information received from a geographic information system; and
determine the mode of travel based on the comparison.

3. The system of claim 1, wherein the movement module is configured to receive current movement information from a global positioning system supported by the mobile device; and
wherein the travel mode module is configured to determine the mode of travel based on the received current movement information.

4. The system of claim 1, further comprising:
a travel context module that is configured to access context information associated with the determined mode of travel;
wherein the icon display module is configured to cause an icon to be displayed that is based on the determined mode of travel and on the context information.

5. The system of claim 1, further comprising:
a travel context module that is configured to access context information associated with the determined mode of travel;
wherein the icon display module is configured to cause an icon to be displayed that graphically changes based on the context information.

6. The system of claim 1, wherein the icon display module is configured to:
identify a sponsor associated with the determined module of travel; and
cause an icon to be displayed that is associated with the identified sponsor.

7. The system of claim 1, further comprising:
a map display module that is configured to display map elements via the mapping application that are associated with the displayed icon.

8. The system of claim 1, wherein the travel mode module is configured to determine that a user associated with the mobile device is walking; and wherein the icon display module is configured to cause a display element of a walking person to be displayed via the mapping application.

9. The system of claim 1, wherein the travel mode module is configured to determine that a user associated with the mobile device is driving a car; and wherein the icon display module is configured to cause a display element of a car to be displayed via the mapping application.

10. The system of claim 1, wherein the travel mode module is configured to determine that a user associated with the mobile device is driving traveling via public transportation; and wherein the icon display module is configured to cause a display element of a bus, a subway, or a train to be displayed via the mapping application.

11. A method performed by a mobile device, comprising:
accessing information identifying a movement of a mobile device;
determining a mode of travel of the mobile device; and
causing an icon to be displayed, via a mapping application supported by the mobile device, which is based on the determined mode of travel.

12. The method of claim 11, wherein accessing information identifying a movement of a mobile device includes receiving current movement information from a global positioning system supported by the mobile device; and wherein determining a mode of travel of the mobile device includes:
comparing the received current movement information to information received from a geographic information system; and
determining the mode of travel based on the comparison.

13. The method of claim 11, wherein accessing information identifying a movement of a mobile device includes receiving current movement information from a global positioning system supported by the mobile device; and
determining a mode of travel of the mobile device includes determining the mode of travel based on the received current movement information.

14. The method of claim 1, further comprising:
accessing context information associated with the determined mode of travel;
wherein the icon to be displayed is based on the determined mode of travel and on the context information.

15. The method of claim 11, further comprising:
accessing context information associated with the determined mode of travel;
wherein the icon to be displayed graphically changes based on the context information.

16. The method of claim 11, wherein causing an icon to be displayed that is based on the determined mode of travel includes:
identifying a sponsor associated with the determined module of travel; and
causing an icon to be displayed that is associated with the identified sponsor.

17. The method of claim 11, further comprising:
displaying map elements via the mapping application that are associated with the displayed icon.

18. A computer-readable storage medium whose contents, when executed by a mobile device, cause the mobile device to perform operations, comprising:
accessing information identifying a current mode of travel of a mobile device;
selecting a map icon associated with the identified current mode of travel; and
displaying the selected map icon associated with the identified current mode of travel via a mapping application that is supported by the mobile device; the mapping application displaying a map via a user interface of the mobile device that includes the selected map icon.

19. The computer-readable storage medium of claim 18, further comprising:
displaying map elements via the mapping application that are associated with the displayed icon.

20. The computer-readable storage medium of claim 18, wherein accessing information identifying a current mode of travel of a mobile device includes accessing information from a global positioning system of the mobile device that identifies a current geographic location of the mobile device.
